(19) United States
(12) Patent Application Publication
(10) Pub. No.: US 2024/0397000 A1
(43) Pub. Date: Nov. 28, 2024

(54) SYSTEMS AND METHODS FOR ACCESS AND MOBILITY POLICY CONTROL ESTABLISHMENT

(71) Applicant: Verizon Patent and Licensing Inc., Basking Ridge, NJ (US)

(72) Inventors: Violeta Cakulev, Millburn, NJ (US); Lixia Yan, Basking Ridge, NJ (US); Shanthala Kuravangi-Thammaiah, Keller, TX (US); Lalit R. Kotecha, San Ramon, CA (US)

(21) Appl. No.: 18/321,302

(22) Filed: May 22, 2023

(51) Int. Cl. H04M 15/00; H04L 12/14; H04W 8/08

(52) U.S. Cl. CPC H04M 15/66; H04L 12/14; H04W 8/08

(57) ABSTRACT

A method may include receiving, by an access and mobility management function (AMF), a registration request from a user equipment (UE) device, and obtaining, by the AMF, at least one of subscriber-related information associated with the UE device or information associated with the UE device from a charging function (CHF). The method may also include determining, by the AMF and based on the obtained information, whether to establish an access and mobility (AM) policy association for the UE device. The method may further include initiating, in response to determining that the AM policy association for the UE device is to be established, the AM policy association for the UE device.

### BACKGROUND INFORMATION

In Fifth Generation (5G) network environments defined in accordance with the 3rd Generation Partnership Project (3GPP), a policy control function (PCF) may provide access and mobility (AM) related information to an access and mobility management function (AMF). For example, the PCF may identify AM policies to control service area restrictions, specify a radio access technology (RAT) frequency selection priority (RFSP) index that defines spectrum permissions that apply to user equipment (UE) devices, etc. The AMF may then determine whether to establish an AM policy association for a UE device data session based on local policies stored at the AMF.

### BRIEF DESCRIPTION OF THE DRAWINGS

FIG. 1 illustrates an exemplary environment in which systems and methods described herein may be implemented;

FIG. 2 is a block diagram of components implemented in the environment of FIG. 1 in accordance with an exemplary implementation;

FIG. 3 illustrates logic components implemented in one or more of the devices illustrated in FIGS. 1 and 2 in accordance with an exemplary implementation;

FIG. 4 is a flow diagram illustrating processing associated with establishing an AM policy association in accordance with an exemplary implementation;

FIG. 5 is an exemplary signal flow diagram associated with the processing of FIG. 4;

FIG. 6 is another exemplary signal flow diagram associated with establishing an AM policy association in accordance with another exemplary implementation; and

FIG. 7 is still another exemplary signal flow diagram associated with establishing an AM policy association in accordance with still another exemplary implementation.

### DETAILED DESCRIPTION OF EXAMPLE EMBODIMENTS

The following detailed description refers to the accompanying drawings. The same reference numbers in different drawings may identify the same or similar elements.

Implementations described herein enable decisions regarding establishing an AM policy association for UE devices to be influenced by certain types of information, such as subscription-based information and/or charging-related information. In one exemplary implementation, a unified data management (UDM) element and/or unified data repository (UDR) may store subscription-related information that indicates whether an AM policy association is to be established for a UE device. This information may then be provided to the AMF during a UE device registration to aid in determining whether to establish an AM policy association for the UE device. In another exemplary implementation, a charging function (CHF) may provide information to the AMF indicating whether to establish an AM policy association for a UE device. In still another exemplary implementation, information from both the UDM/UDR and CHF may be provided to the AMF to aid in determining whether to establish an AM policy association for a UE device. In this manner, an AM policy association may be provided to UE devices based on information particular to those UE devices.

The term “AM policy association” as used herein should be broadly construed to refer to access and mobility policies and policy-related processing. For example, AM policy association may refer to a policy to control service area restrictions (e.g., a list of allowed tracking area identities (TAIs), non-allowed TAIs), a policy that specifies an RFSP index that defines spectrum permissions to apply to a UE device, a policy that defines a UE aggregate maximum bit rate (AMBR), a policy defining traffic steering/routing, a policy defining network slice enablement and other policies, services and/or functionalities associated with access and mobility.

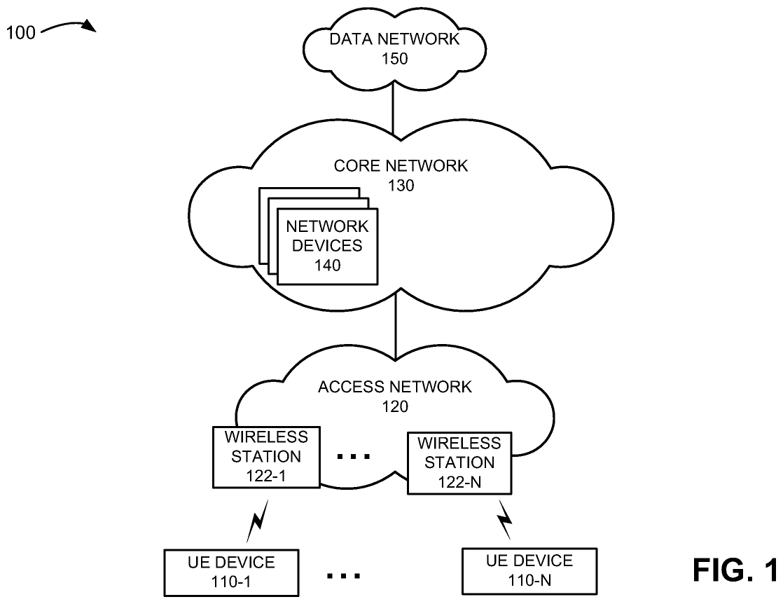

FIG. 1 is a diagram illustrating an exemplary environment 100 in which systems and methods described herein may be implemented. Referring to FIG. 1, environment 100 includes user equipment (UE) devices 110-1 through 110-N, access network 120, wireless stations 122-1 through 122-N, core network 130, network devices 140 and data network 150.

UE devices 110-1 and 110-N(referred to herein individually as UE device or UE 110, and collectively as UE devices or UEs 110) may include any computing device, such as a personal computer (PC), a laptop computer, a server, a tablet computer, a notebook, a Chromebook®, a mobile device, such as wireless or cellular telephone device (e.g., a conventional cell phone with data processing capabilities), a smart phone, a personal digital assistant (PDA) that can include a radiotelephone, any type of mobile computer device or system, a game playing device, a music playing device, a home appliance device, a home monitoring device, a virtualized system, an Internet of Things (IoT) device, a machine type communication (MTC) device, etc., that includes communication functionality. UE device 110-1 may connect to access network 120 via wireless station 122-1 and UE device 110-N may connect to access network 120 via wireless station 122-N. UE devices 110 may also connect to other devices in environment 100 via other techniques, such as wired, wireless, optical connections or a combination of these techniques. UE device 110 and a person that may be associated with UE device 110 (e.g., the party holding or using UE device 110) may be referred to collectively as UE device 110 or UE 110 in the description below.

Access network 120 may provide access to core network 130 for wireless devices, such as UE devices 110. Access network 120 may enable UE device 110 to connect to core network 130 for Internet access, non-Internet Protocol (IP) data delivery, cloud computing, mobile telephone service, Short Message Service (SMS) message service, Multimedia Message Service (MMS) message service, and/or other types of data services. Access network 120 may provide access to core network 130, a service or application layer network, a cloud network, a multi-access edge computing (MEC) network, a fog network, etc. Furthermore, access network 120 may enable a device in core network 130 to exchange data with UE device 110 using a non-IP data delivery method such as Data over Non-Access Stratum (DoNAS).

Access network 120 may also include a 5G access network or another advanced network, such as a Fourth Generation (4G) Long Term Evolution (LTE) access network. For example, access network 120 may include the functionality of a 5G network, such as 5G Radio Access Network (RAN) communicating via mmWave technology, a 5G RAN communicating via C-band technology or other types of 5G networks. Access network 120 may also include a 4G RAN.

Access network 120 may also include: support for advanced or massive multiple-input and multiple-output (MIMO) antenna configurations (e.g., an 8×8 antenna configuration, a 16×16 antenna configuration, a 256×256 antenna configuration, etc.); support for cooperative MIMO (CO-MIMO) configurations; support for carrier aggregation; relay stations; Heterogeneous Networks (HetNets) of overlapping small cells and macrocells; Self-Organizing Network (SON) functionality; machine type communication (MTC) functionality, such as 1.4 MHz wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of 5G functionality.

Wireless stations 122 (referred to collectively as wireless stations 122 and individually as wireless station 122) may be included in access network 120. Each wireless station 122 may service a number of UE devices 110 and/or other user devices when the particular device is within radio frequency range of wireless station 122. In one implementation, wireless station 122 may include 5G base station (e.g., a next generation NodeB (gNB)) that includes one or more radio frequency (RF) transceivers. For example, wireless station 122 may include three RF transceivers and each RF transceiver may service a 120 degree sector of a 360 degree field of view. Each RF transceiver may include or be coupled to an antenna array. The antenna array may include an array of controllable antenna elements configured to send and receive 5G new radio (NR) wireless signals via one or more antenna beams. In other implementations, wireless station 122 may also include a 4G base station (e.g., an evolved NodeB (eNodeB)) or a 6G base station that communicates wirelessly with UEs 110 located within the radio frequency range of wireless station 122.

Core network 130 may include one or more wired, wireless and/or optical networks that are capable of receiving and transmitting data, voice and/or video signals. In an exemplary implementation, core network 130 may be associated with a telecommunications service provider (e.g., a service provider providing cellular wireless communication services and wired communication services) and may manage communication sessions of UE devices 110 connecting to core network 130 via access network 120. Core network 130 may include one or multiple networks of different types and technologies. For example, core network 130 may be implemented to include a next generation core (NGC) network for a 5G network, an Evolved Packet Core (EPC) of an LTE or LTE Advanced network, a sixth generation (6G) network, and/or a legacy core network. Core network 130 may provide packet-switched services and wireless IP connectivity to various components in environment 100, such as UE devices 110, to provide, for example, data, voice, and/or multimedia services.

Core network 130 may include various network devices 140. Depending on the implementation, network devices 140 may include 5G core network components (e.g., a User Plane Function (UPF), an Access and Mobility Management Function (AMF), a Session Management Function (SMF), a Unified Data Management (UDM) function, a Unified Data Repository (UDR), a Policy Control Function (PCF), an access management-policy control function (AM-PCF), a session management-policy control function (SM-PCF), a Charging Function (CHF), a network exposure function (NEF), an application function (AF), etc.), 4G core network components (e.g., a Serving Gateway (SGW), a Packet data network Gateway (PGW), a Mobility Management Entity (MME), a Home Subscriber Server (HSS), a Policy Charging and Rules Function (PCRF) etc.), or another type of core network components (e.g., future 6G network components). In other implementation, network devices 140 may include combined 4G and 5G functionality, such as a session management function with PGW-control plane (SMF+PGW-C) and a user plane function with PGW-user plane (UPF+PGW-U).

Data network 150 may include, for example, a packet data network. In an exemplary implementation, UE device 110 may connect to data network 150 via core network 130. Data network 150 may also include and/or be connected to a local area network (LAN), a wide area network (WAN), a metropolitan area network (MAN), an autonomous system (AS) on the Internet, an optical network, a cable television network, a satellite network, a wireless network, an ad hoc network, a telephone network (e.g., the Public Switched Telephone Network (PSTN) or a cellular network), an intranet, or a combination of networks.

The exemplary configuration illustrated in FIG. 1 is provided for simplicity. It should be understood that a typical environment may include more or fewer devices than illustrated in FIG. 1. For example, environment 100 may include a large number (e.g., thousands or more) of UE devices 110 and wireless stations 122, as well as multiple access networks 120, core networks 130 and data networks 150. Environment 100 may also include elements, such as gateways, monitoring devices, network elements/functions, etc. (not shown), that aid in providing data services and routing data in environment 100.

Various functions are described below as being performed by particular components in environment 100. In other implementations, various functions described as being performed by one device may be performed by another device or multiple other devices, and/or various functions described as being performed by multiple devices may be combined and performed by a single device.

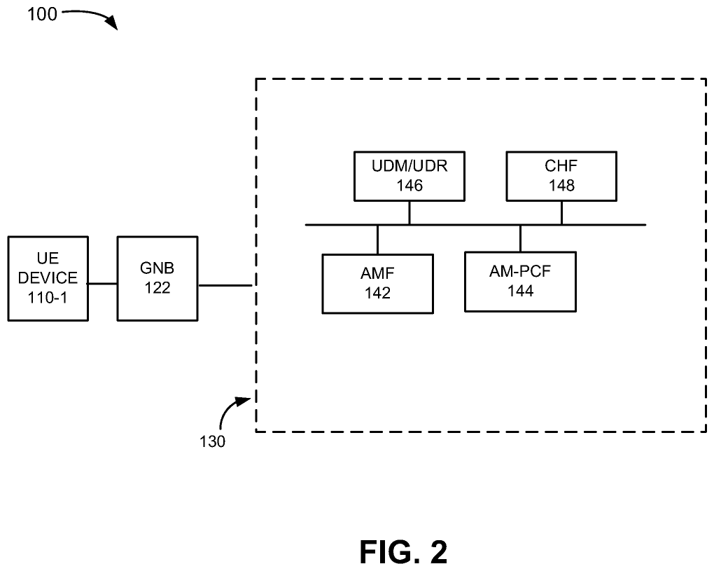

FIG. 2 illustrates a portion of environment 100, including elements implemented in core network 130 in accordance with an exemplary implementation. Referring to FIG. 2, network devices 140 in core network 130 may include AMF 142, AM-PCF 144 (also referred to herein as PCF 144), UDM/UDR 146 and CHF 148. It should be understood that core network 130 may include other elements/functions, such as those elements/functions described above with respect to FIG. 1, and/or differently arranged elements. Environment 100 also includes UE device 110-1 and wireless station 122 (depicted as gNB 122).

AMF 142 may perform registration management, connection management, reachability management, mobility management, lawful intercepts, Short Message Service (SMS) transport between UE device 110 and other network functions (NFs), session management messages transport between UE device 110 and an SMF (not shown), access authentication and authorization, location services management, functionality to support non-3GPP access networks, and/or other types of management processes. In exemplary implementations, AMF 142 may obtain information from other devices, such as UDM/UDR 146 and/or CHF 148, to determine whether to establish an AM policy association for a UE device 110, as described in detail below.

AM-PCF 144 may perform policy control functions, as well as some access management functions. For example, AM-PCF 144 may support policies to control network behavior, provide policy rules to control plane functions, access subscription information relevant to policy decisions, generate policy decisions, and/or perform other types of processes associated with policy enforcement. In an exemplary implementation, AM-PCF 144 may receive an AM policy association establishment request from AMF 142 during a UE device 110 registration, and establish an AM policy association for the UE device 110, as described in detail below.

UDM/UDR 146, shown as a single device in FIG. 2 may include both a UDM and a UDR. The UDM and UDR may be referred to together herein as UDM/UDR 146. The UDM portion of UDM/UDR 146 may maintain subscription information for UE devices 110, manage subscriptions, generate authentication credentials, handle user identification, perform access authorization based on subscription data, perform network function registration management, maintain service and/or session continuity by maintaining assignment of an SMF (not shown) for ongoing sessions, support Short Message Service (SMS) delivery, support lawful intercept functionality, and/or perform other processes associated with managing user data. The UDR portion of UDM/UDR 146 may store the subscription information obtained and managed by the UDM. For example, the UDR may store subscription information and subscriber profile information obtained by the UDM. In an exemplary implementation, UDM/UDR 146 may provide AM policy association information to AMF 142 when a UE device 110 is registering, as described in detail below.

CHF 148 may perform charging and/or billing functions for core network 130. For example, CHF 148 may generate a charging record for UE device 110 based on data flow information associated with UE device 110. In an exemplary implementation, CHF 148 may provide AM policy association information to AMF 142 when a UE device 110 is registering, as described in detail below.

Environment 100 illustrated in FIG. 2 may include additional elements and/or NFs that are not illustrated. Such elements and/or NFs may provide security, authentication and authorization, network polices, subscriber profiles, network slicing, and/or facilitate the operation of core network 130. It should also be understood that functions described as being performed by various elements in FIG. 2, including elements in core network 130, may be performed by other elements/functions in other implementations.

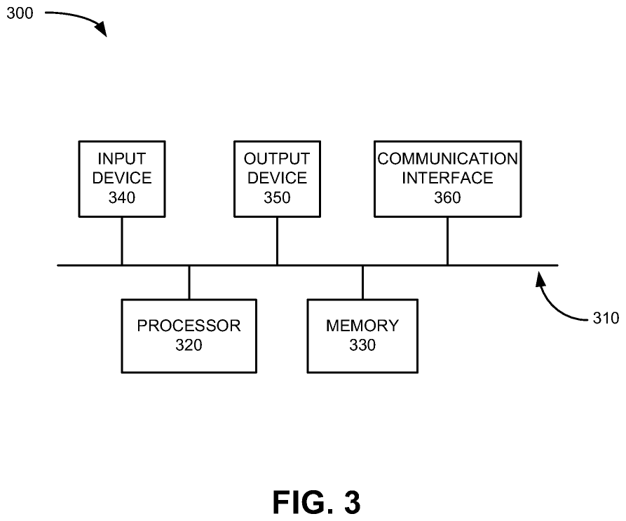

FIG. 3 illustrates an exemplary configuration of a device 300. One or more devices 300 may correspond to or be included in devices in environment 100, such as UE device 110, wireless station 122, network devices 140, such as AMF 142, AM-PCF 144, UDM/UDR 146, CHF 148 and other devices included in environment 100. Referring to FIG. 3, device 300 may include bus 310, processor 320, memory 330, input device 340, output device 350 and communication interface 360. The exemplary configuration illustrated in FIG. 3 is provided for simplicity. It should be understood that device 300 may include more or fewer components than illustrated in FIG. 3.

Processor 320 may include one or more processors, microprocessors, or processing logic that may interpret and execute instructions. Memory 330 may include a random access memory (RAM) or another type of dynamic storage device that may store information and instructions for execution by processor 320. Memory 330 may also include a read only memory (ROM) device or another type of static storage device that may store static information and instructions for use by processor 320. Memory 330 may further include a solid state drive (SSD). Memory 330 may also include a magnetic and/or optical recording medium (e.g., a hard disk) and its corresponding drive.

Input device 340 may include a mechanism that permits a user to input information, such as a keypad, a keyboard, a mouse, a pen, a microphone, a touch screen, voice recognition and/or biometric mechanisms, etc. Output device 350 may include a mechanism that outputs information to the user, including a display (e.g., a liquid crystal display (LCD)), a speaker, etc. In some implementations, device 300 may include a touch screen display may act as both an input device 240 and an output device 350.

Communication interface 360 may include one or more transceivers that device 300 uses to communicate with other devices via wired, wireless or optical mechanisms. For example, communication interface 360 may include one or more radio frequency (RF) transmitters, receivers and/or transceivers and one or more antennas for transmitting and receiving RF data. Communication interface 360 may also include a modem or an Ethernet interface to a LAN or other mechanisms for communicating with elements in a network.

In an exemplary implementation, device 300 performs operations in response to processor 320 executing sequences of instructions contained in a computer-readable medium, such as memory 330. A computer-readable medium may be defined as a physical or logical memory device. The software instructions may be read into memory 330 from another computer-readable medium (e.g., a hard disk drive (HDD), SSD, etc.), or from another device via communication interface 360. Alternatively, hard-wired circuitry may be used in place of or in combination with software instructions to implement processes consistent with the implementations described herein. Thus, implementations described herein are not limited to any specific combination of hardware circuitry and software.

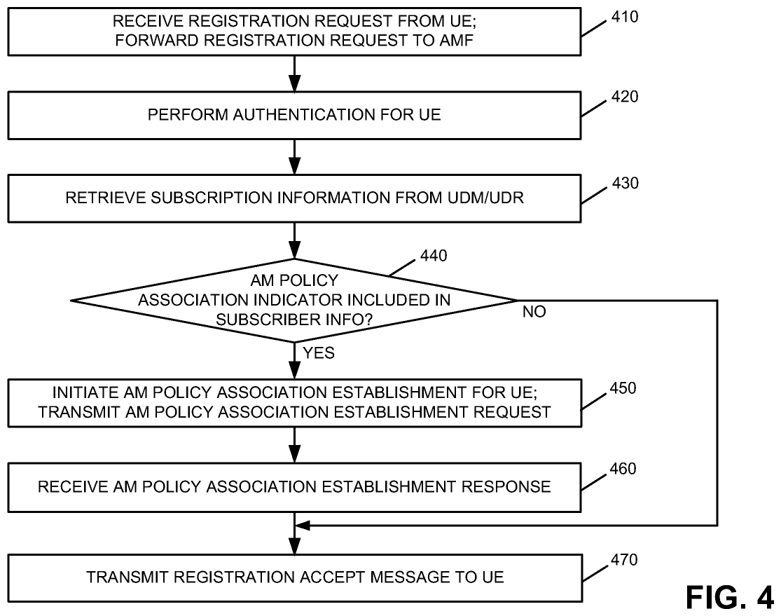

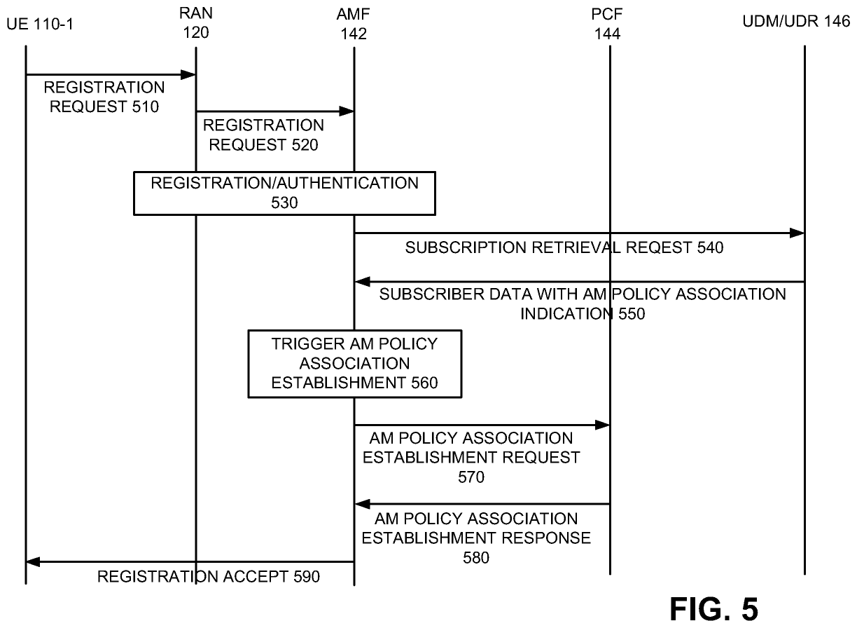

FIG. 4 is a flow diagram illustrating processing associated with AM policy association establishment with respect to UE devices 110 in accordance with an exemplary implementation. FIG. 5 is a signal flow diagram illustrating exemplary signal flows associated with the processing of FIG. 4. Processing may begin with a UE device 110 transmitting a registration request and RAN 120 receiving the registration request (block 410; FIG. 5, 510). For example, UE 110-1 may transmit a registration request for a connection and wireless station 122-1 may receive the registration request. RAN 120 may forward the registration request to AMF 142 (block 410; FIG. 5, 520).

AMF 142 may receive the registration request and perform authentication associated with registering UE 110-1 (block 420; FIG. 5, block 530). For example, AMF 142 may interact with devices/elements in environment 100 (e.g., UE 110-1, RAN 120, UDM/UDR 146 and/or other elements) to determine if UE 110-1 is authorized to establish a data session, such as whether UE 110-1 is associated with a subscriber to core network 130. For this example, assume that UE 110-1 is authenticated.

AMF 142 may retrieve subscription information associated with UE 110-1 from UDM/UDR 146 (block 430). For example, AMF 142 may transmit a subscription retrieval request to UDM/UDR 146 (FIG. 5, 540). In an exemplary implementation, UDM/UDR 146 may store subscriber data, as well as an AM policy association indication for particular UE devices 110. For example, UDM/UDR 146 may store an AM policy association indication that indicates that an AM policy association is to be established for particular UE devices 110, such as UE devices 110 associated with premium subscribers, UE devices 110 associated with subscribers having a particular quality of service (QOS) or service level agreement (SLA) requirements, etc. In each case, UDM/UDR 146 may provide the subscriber data and the AM policy association indication (e.g., an AM policy association information element (IE)) for UE 110-1 to AMF 142 (FIG. 5, 550).

AMF 142 may receive the information from UDM/UDR 146 and determine whether an AM policy association indicator is included with the subscription information received from UDM/UDR 146 (block 440). If AMF 142 determines that an AM policy association indicator is included with the subscription information (block 440—yes), AMF 142 may trigger or initiate establishment of an AM policy association for UE 110-1 (block 450; FIG. 5, block 560). For example, AMF 142 may send an AM Policy Association Establishment Request message to PCF 144 (block 450; FIG. 5, 570). PCF 144 may receive the AM Policy Association Request Establishment message and transmit an AM Policy Association Establishment response message to AMF 142 (FIG. 5, 580). AMF 142 may receive the AM Policy Association Establishment response message (block 460), and transmit a Registration Accept message to UE 110 (block 470; FIG. 5, 590). In this scenario, the UE device 110-1 data session (e.g., protocol data unit (PDU) session) will be established in accordance with the AM policy association based on the information stored in UDM/UDR 146 and provided to AMF 142 during the UE device 110-1 registration.

Returning to block 440, if AMF 142 determines that no AM policy association indicator is provided by UDM/UDR 146 for UE 110-1 (block 440—no), AMF 142 may transmit a Registration Accept message to UE 110 (block 470). In this case, the UE session will not be established based on AM policy association information. By not establishing an AM policy association in situations in which no AM policy association is warranted, the amount of signaling overhead and/or latency/delays associated with establishing a UE device 110 data session may be reduced. For example, by eliminating messages 570 and 580, signaling, latency and delays may be reduced.

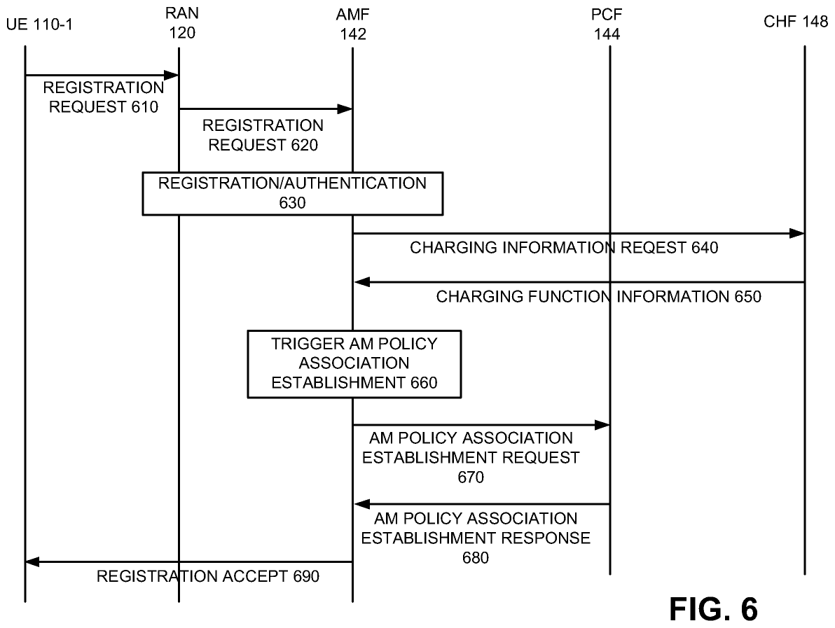

FIG. 6 is a signal flow diagram illustrating exemplary signal flows associated with an AM policy association establishment in accordance with another exemplary implementation. Processing may begin in a similar manner as that described above with respect to FIGS. 4 and 5. For example, UE 110-1 may transmit a registration request to RAN 120 (610), and RAN 120 may forward the registration request to AMF 142 (620). AMF 142 may receive the registration request and perform authentication associated with registering UE 110-1 (block 630). For example, AMF 142 may interact with devices/elements in environment 100 (e.g., UE 110-1, RAN 120, UDM/UDR 146 and/or other elements) to determine if UE 110-1 is authorized to establish a data session, such as whether UE 110-1 is associated with a subscriber to core network 130. As above, for this example, assume that UE 110-1 is authenticated.

AMF 142 may retrieve information associated with UE 110-1 from CHF 148. For example, AMF 142 may transmit a charging information-related request to CHF 148 (640). In an exemplary implementation, CHF 148 may store and monitor charging-related data for UE devices 110, as well as store an AM policy association indication for particular UE devices 110. For example, CHF 148 may monitor registration requests and other events in environment 100. CHF 148 may use the monitored events to determine whether an AM policy association is to be established for particular UE devices 110. For example, CHF 148 may monitor the number of registrations for UE 110-1 during a period of time (e.g., one day). If the number of registrations exceeds a predetermined number (e.g., five registrations, 10 registrations, etc., in a single 24 hour period), CHF 148 may store an AM policy association indication for that UE device 110. In this example, if the current number of UE 110-1 registrations exceeds the predetermined number in the period of time, CHF 148 may provide the AM policy association indication to AMF 142. In each case, CHF 148 may provide information indicating whether the AM policy association is to be established for UE 110-1 (650).

AMF 142 may receive the information from CHF 148 and determine whether an AM policy association indicator is included with the information received from CHF 148. If AMF 142 determines that an AM policy association indicator is included with the information, AMF 142 may trigger or initiate establishment of an AM policy association for UE 110-1 (block 660). For example, AMF 142 may send an AM Policy Association Establishment Request message to PCF 144 (670). PCF 144 may receive the AM Policy Association Request Establishment message and transmit an AM Policy Association Establishment response message to AMF 142 (680). AMF 142 may receive the AM Policy Association Establishment response message, and transmit a Registration Accept message to UE 110 (690). In this scenario, the UE device 110-1 data session will be established in accordance with the AM policy association.

If, however, AMF 142 determines that no AM policy association indicator is provided by CHF 148 for UE 110-1, AMF 142 may transmit a Registration Accept message to UE 110 (690). In this case, the UE session will not be established based on AM policy association information. As described above with respect to FIGS. 4 and 5, by not establishing an AM policy association in situations in which no AM policy association is warranted, the amount of signaling and/or latency/delays associated with establishing a UE device 110 data session may be reduced. For example, by eliminating messages 670 and 680, signaling, latency and delays may be reduced.

As described above with respect to FIGS. 4 and 5, information from UDM/UDR 146 may be used to aid in determining whether to establish an AM policy association for a UE 110. As also described above with respect to FIG. 6, information from CHF 148 may be used to aid in determining whether to establish an AM policy association for a UE 110. In still another implementation, information from both UDM/UDR 146 and CHF 148 may be used to influence or aid in determining to establish and AM policy association.

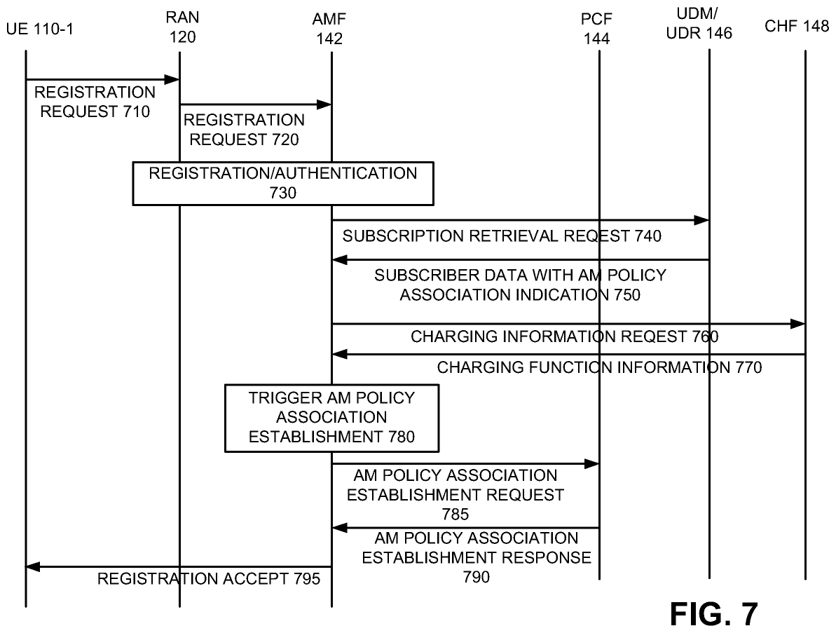

For example, FIG. 7 is a signal flow diagram illustrating exemplary signal flows associated with an AM policy association establishment in accordance with still another exemplary implementation. Processing may begin in a similar manner as that described above with respect to FIGS. 5 and 6. That is, UE 110-1 may transmit a registration request to RAN 120 (710), RAN 120 may forward the registration request to AMF 142 (720) and AMF 142 may interact with devices/elements in environment 100 (e.g., UE 110-1, RAN 120, UDM/UDR 146 and/or other elements) to perform authentication associated with registering UE 110-1 (block 730). Assume that UE 110-1 is authenticated.

AMF 142 may retrieve information associated with UE 110-1 from UDM/UDR 146. For example, AMF 142 may transmit a subscription retrieval request to UDM/UDR 146 (740) and receive subscription information along with an indication whether an AM policy association is to be established for UE 110-1 (750). AMF 142 may also transmit a charging information-related request to CHF 148 (760). As described above, in an exemplary implementation, CHF 148 may store and monitor charging-related data for UE devices 110, as well as store an AM policy association indication for particular UE devices 110, based on, for example, monitored registration requests and/or other events in environment 100. In each case, CHF 148 may store an AM policy association indication for each UE device 110. CHF 148 may provide the AM policy association indication for UE 110-1 to AMF 142 (770).

AMF 142 may receive the information from UDM/UDR 146 and CHF 148 and determine whether an AM policy association indicator is included with the information received from either UDM/UDR 146 or CHF 148. If AMF 142 determines that AM policy association indicator is included with the information from either UDM/UDR 146 or CHF 148, AMF 142 may trigger or initiate an AM policy association for UE 110-1 (block 780). For example, AMF 142 may send an AM Policy Association Establishment Request message to PCF 144 (785). PCF 144 may receive the AM Policy Association Establishment Request message and transmit an AM Policy Association Establishment response message to AMF 142 (790). AMF 142 may receive the AM Policy Association Establishment response message, and transmit a Registration Accept message to UE 110 (795). In this scenario, the UE device 110-1 data session will be established in accordance with the AM policy association.

If, however, AMF 142 determines that no AM policy association indicator is provided by UDM/UDR 146 or CHF 148 for UE 110-1, AMF 142 may transmit a Registration Accept message to UE 110 (795). In this case, the UE session will not be established based on AM policy association information. As described above with respect to FIGS. 4-6, by not establishing an AM policy association in situations in which no AM policy association is warranted, the amount of signaling and/or latency/delays associated with establishing a UE device 110 data session may be reduced. For example, by eliminating messages 785 and 790, signaling, latency and delays may be reduced.

In other implementations, AMF 142 may determine that an AM policy association is to be established only when both the UDM/UDR 146 and CHF 148 provide an AM policy association indicator to AMF 142, based on the particular network requirements. In such implementations, AMF 142 may initiate the AM policy association as described above with respect to block 780 and messages 785-795 when both the UDM/UDR 146 and CHF 148 provide an AM policy association indicator to AMF 142.

As described above, implementations have been described above with AMF 142 establishing an AM policy association determination based on information provided by UDM/UDR 146 and/or CHF 148. In other implementations, other network functions/elements may interface with AMF 142 to aid in determining whether to establish an AM policy association for a UE device 110 data session.

Implementations described herein provide for determining whether to establish an AM policy association for a UE device data session based on particular information, such as information provided by a UDM/UDR and/or information provided by a CHF. In this manner, an AMF or other network function/element is able to establish or provide an AM policy association based on information particular to those UE devices. In addition, not establishing an AM policy association when not needed allows the service provider to avoid extra signaling overhead and reduce delay in establishing a UE device data session.

The foregoing description of example implementations provides illustration and description, but is not intended to be exhaustive or to limit the embodiments to the precise form disclosed. Modifications and variations are possible in light of the above teachings or may be acquired from practice of the embodiments.

In addition, features have been described with respect to generating AM policy association decisions using elements in core network 130. In other implementations, similar processing may be performed in other portions of environment 100, such as in a Multi-access Edge Computing (MEC) platform located, for example, between access network 120 and core network 130. In still other implementations, a number of AMFs 142, PCFs 144, UDM/UDRs 146 and/or CHFs 148 may be distributed in environment 100 to generate AM policy association determinations.

Further, features have been described above with respect to an AMF 142 requesting information from a UDM/UDR 146 and/or CHF 148. In other implementations, AMF 142 may subscribe to event information and/or other information from UDM/UDR 146 and/or CHF 148. In such implementations, AMF 142 may obtain the AM policy association information without having to request such information.

Still further, while series of acts have been described with respect to FIG. 4 and signal flows with respect to FIGS. 5-7, the order of the acts and signal flows may be different in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, by an access and mobility management function (AMF), a registration request from a user equipment (UE) device;
obtaining, by the AMF, at least one of subscriber-related information associated with the UE device or information associated with the UE device from a charging function (CHF);
determining, by the AMF and based on the obtained information, whether to establish an access and mobility (AM) policy association for the UE device; and
initiating, in response to determining that the AM policy association for the UE device is to be established, the AM policy association for the UE device.

2. The method of claim 1, wherein the obtaining comprises:
obtaining subscriber-related information for the UE device from at least one of a unified data management (UDM) device or a unified data repository (UDR), wherein the subscriber-related information indicates whether the AM policy association for the UE device is to be established.

3. The method of claim 1, wherein the obtaining comprises:
obtaining information associated with the UE device from the CHF, wherein the information indicates whether the AM policy associated for the UE device is to be established.

4. The method of claim 3, further comprising:
monitoring, by the CHF, actions performed by the UE device; and
signaling, in response to a request from the AMF and based on the monitoring, the AMF to initiate the AM policy association for the UE device.

5. The method of claim 4, wherein the monitoring actions comprises monitoring a number of registrations for the UE device during a period of time.

6. The method of claim 1, wherein the initiating comprises:
transmitting, to a policy control function (PCF), an AM policy association establishment request.

7. The method of claim 1, wherein the obtaining comprises:
obtaining subscriber-related information, and
obtaining information from the CHF.

8. The method of claim 1, wherein the obtaining comprises:
obtaining subscriber-related information associated with the UE device from at least one of a unified data management (UDM) device or a unified data repository (UDR), and
obtaining information associated with the UE device from the CHF.

9. The method of claim 8, wherein the determining comprises:
determining, by the AMF and based on the subscriber-related information and the information from the CHF, whether to establish an AM policy association for the UE device.

10. A system, comprising:
at least one device configured to:
receive a registration request from a user equipment (UE) device;
obtain at least one of subscriber-related information associated with the UE device or information associated with the UE device from a charging function (CHF);
determine, based on the obtained information, whether to establish an access and mobility (AM) policy association for the UE device; and
initiate, in response to determining that the AM policy association for the UE device is to be established, the AM policy association for the UE device.

11. The system of claim 10, wherein the at least one device comprises an access and mobility management function (AMF) and at least one of a unified data management (UDM) device, a unified data repository (UDR) or a charging function (CHF).

12. The system of claim 10, wherein when obtaining, the at least one device is configured to:
obtain subscriber-related information for the UE device from at least one of a unified data management (UDM) device or a unified data repository (UDR), wherein the subscriber-related information indicates whether the AM policy association for the UE device is to be established.

13. The system of claim 10, wherein the at least one device is configured to:
monitor actions performed by the UE device, and
store, based on the monitoring, whether the AM policy association is to be established for the UE device.

14. The system of claim 13, wherein the monitoring actions comprises:
monitoring actions performed by the UE device over a period of time, and
determining whether to initiate the AM policy association for the UE devices based on the monitored actions over the period of time.

15. The system of claim 10, wherein when initiating, the at least one device is further configured to:
transmit, to a policy control function (PCF), an AM policy association establishment request.

16. The system of claim 15, wherein when obtaining, the at least one device is configured to:
obtain subscriber-related information, and
obtain information from the CHF.

17. The system of claim 16, wherein when determining, the at least one device is configured to:
determine, based on the subscriber-related information and the information from the CHF, whether to establish an AM policy association for the UE device.

18. A non-transitory computer-readable medium having stored thereon sequences of instructions which, when executed by at least one processor, cause the at least one processor to:
receive a registration request from a user equipment (UE) device;
obtain at least one of subscriber-related information associated with the UE device or information associated with the UE device from a charging function (CHF);
determine, based on the obtained information, whether to establish an access and mobility (AM) policy association for the UE device; and
initiate, in response to determining that the AM policy association for the UE device is to be established, the AM policy association for the UE device.

19. The non-transitory computer-readable medium of claim 18, wherein when obtaining information, the instructions cause the at least one processor to:
obtain subscriber-related information for the UE device from at least one of a unified data management (UDM) device or a unified data repository (UDR), wherein the subscriber-related information indicates whether the AM policy association for the UE device is to be established.

20. The non-transitory computer-readable medium of claim 18, wherein when obtaining information, the instructions cause the at least one processor to:
obtain information associated with the UE device from the CHF, wherein the information indicates whether the AM policy associated for the UE device is to be established.
